(19) United States
(12) Patent Application Publication
(10) Pub. No.: US 2022/0053612 A1
(43) Pub. Date: Feb. 17, 2022

(54) HEATER ELEMENT INCORPORATING PRIMARY CONDUCTOR FOR USE IN A HIGH-SPEED OVEN

(71) Applicant: DE LUCA OVEN TECHNOLOGIES, LLC, San Francisco, CA (US)

(72) Inventors: Nicholas P. DE LUCA, San Francisco, CA (US); Andrew PERKINS, San Francisco, CA (US); James MINARD, San Francisco, CA (US)

(21) Appl. No.: 17/275,435

(22) PCT Filed: Sep. 12, 2019
(86) PCT No.: PCT/US2019/050805

§ 371 Date: Mar. 11, 2021

Related U.S. Application Data
(60) Provisional application No. 62/730,878, filed on Sep. 13, 2018.
(60) Provisional application No. 62/730,893, filed on Sep. 13, 2018.

(51) Int. Cl. H05B 3/24; F24C 7/04

(52) U.S. Cl. CPC H05B 3/24; H05B 2203/002; H05B 2203/017; F24C 7/043

(57) ABSTRACT

A heater element including: a primary conductor formed from a single sheet of metal, wherein the primary conductor is capable of radiating heat within 5 seconds and has a DeLuca Element Ratio of less than 2 ohms/m2; and primary conductor bars that are not welded to the primary conductor.

### FIELD

The present disclosure teaches a radiative heater for use in a high speed oven formed from a single material stock or mesh and further incorporating two more sections of different thickness and density adjusted to optimally deliver heat to an item to be cooked. The heater element allowing for use at low voltages with a De Luca Element ratio of less than 2 when made to a 0.25 m×0.25 m area and with a resistance measured across the oven length and further allowing for heat ramp up to maximum temperature in less than 3 seconds. The heater element further including ends with a lower electrical resistance so as to allow connectivity of elements in series and further insure that the ends do not over heat as well as to facilitate the proper clamping and tensioning of the element. The heater may also include an optimized pathway at the union end to minimize current concentrations and allow for an even resistive path length.

### BACKGROUND

The use of heater mesh is fully described by De Luca in U.S. Patent number US20100166397 as a means to safely deliver high power at a low voltage to an oven heating cavity. Typical means described by De Luca for delivering a high power output at a wavelength of 1-3 microns (which is most ideal for cooking food items such as toast) involves use of an element which when forming an oven of 0.25 m×0.25 m with a top and bottom element in parallel has the typical characteristic of having a ratio of its resistance to a black body radiative surface area of less than 2 ohms/m2. A similar mesh can also be created with flat stock material formed by a punching, waterjet cutting, chemical etching, laser cutting, electrical discharge machining, or other processes and could be considered an obvious extension for someone skilled in the field. Creating a mesh with a cut pattern that is tailored to provide the correct resistance at an appropriate driving voltage such as 12-24 volts is a further simple extension of the art and this mesh will have a DER of less than two if formed into an oven with a cooking area of 0.25 meters by 0.25 meters for a typical oven (or 0.0625m2).

In patent application US2016/013183 De Luca et al. describe a primary and secondary electrical conductor system used to connect a mesh to a high current source. The primary and secondary conductor bars allow for the transfer of electrical energy to the mesh in an even manner so as to extend the life of the DOT element.

The mesh is intended to be a replaceable item in the oven and thus in order to reduce its costs rather than connecting directly to a large bus bar which would then also need to be replaced and thus add significant cost, a smaller “primary” conductor bar is connected to the heater element and then used to connect to a much larger “secondary” power distribution conductor bar that is non-replaceable.

This primary connection conductor bar is essential as it allows for an even distributed flow of current from the secondary conductor bar that receives energy from the capacitor bank and power supplies. The larger cross sectional area of the secondary conductor bar also insures that it has minimal resistance and thus generates little heat that can adversely affect the connection of the mesh. The use of stainless 304 as a welded primary is typical because the material's chemical constituents of the 304 stainless are similar to those of the Kanthal alloys (i.e. having a high iron content) which are commonly used for the mesh.

The mesh is normally connected to a primary conductor bar through a welded connection. A typical primary conductor bar can be made using a thin 0.010″-0.025 304 stainless bar and then spot welded to the mesh. The secondary bar normally connects mechanically between the power supply, capacitors, and/or switches and the primary conductor bar. Various means for making this electrical connection through mechanical means are further described in the aforementioned patent and include radial pressure on a circular primary, shear on a flat primary, as well as a clamping force between the primary and secondary.

A significant drawback to the process of using a primary conductor bar that needs to be welded involves the associated extra costs of handling and producing the primary parts. These parts can be hard to handle and position when welding to the mesh.

The process of welding a mesh also creates significant potential for discrepancy in the electrical properties at the interface of the primary and the mesh. As an example, contamination between the mesh and primary can cause an inferior weld which then becomes a hot spot during use and leads to early degradation.

A further disadvantage to the welding process involves the misalignment that can occur between the primary conductor bar and the mesh. This misalignment further creates a spot with increased localized tension that can lead to a stress crack and failure as well as skewing of the planer surface which can affect cooking results.

A further disadvantage of welding elements relates to the difficulty of segmenting an element into multiple strips evenly so as to operate at a higher voltage. While the effective DER is not changed if measured according to the methods described by De Luca in U.S. Patent number US20100166397, the use of an element at a higher voltage can be advantageous to reduce the costs associated with voltage conversion using power supplies or transformers. When segmenting a mesh into multiple elements it is difficult to maintain each length equal. The inequality can cause extension of one segment or another and cause deformity of the planar surface when heating.

It is therefore a primary objective of the following invention to provide for a heater element that has a DER of less than 2 (when measured across the width of the oven over an area of 0.25 m×0.25 m and as used in a parallel configuration as described in patent application US20100166397) that has a primary conductor bar (as further described in US patent application US2016/013183) that does not require a separate welding step for manufacturing.

It is a further objective of the current invention that the heater element designed per the above constraint is cool at the junction of the heating portion and that the primary conductor remain cool during use of the element.

It is another objective of the current invention that the heater element designed per the above constraints be able to be tensioned evenly.

It is also an object of the current invention per the above constraints that the element be capable of being segmented in equal segments and further provide pathways for current flow without requiring a welding process.

It is another object of the current invention that the individual cross elements of the mesh be formed in such a way to minimize the chance that particulate matter will create a gap between strands that can further overheat and weaken.

It is a further object of the current invention to minimize the concentration of heat associated with current transfer between non-radiative heating segments.

### SUMMARY

The present teachings provide embodiments of a novel heater element, and features thereof, which offer various benefits. The heater element described herein has a DER of less than two (when measured across the width of the oven over an area of 0.25 m×0.25 m and as used in a parallel configuration as further described in patent application US20100166397) and can be formed by using wire, ribbon, or flat stock. The ends of the mesh are increased in thickness and density so as to provide more material which acts as a primary conductor. In a preferred embodiment, the element is formed using an etching process (such as EDM or chemical etching) that creates two or more distinct thicknesses in the element so as to lower the resistance of the mesh at the integrated primary conductor areas. Specific paths further created at the union end of two or more sections such that the path length provides equal resistance between segments and avoids heat concentrations. The manufacturing process further enabling elements to be formed with quasi-identical segments that allows for ease of tensioning and registration within a secondary conductor and use with higher voltage. The manufacturing process also allowing for formation of a roll of elements located end to end such that a continuous element is created from a single original sheet. Additional coatings can be applied to the element during the manufacturing process which can be done in a continuous automated fashion.

It is to be understood that both the foregoing general description and the following detailed description are exemplary and explanatory and are intended to provide further explanation of the invention as claimed.

### BRIEF DESCRIPTION OF THE FIGURES

The accompanying drawings, which are included to provide a further understanding of the invention and are incorporated in and constitute a part of this specification, illustrate embodiments of the invention, and together with the description serve to explain the principles of the invention.

FIG. 1a is an isometric view of a single wire mesh heating element formed with an integrated primary conductor and having a DER of less than 2.

FIG. 1b is an isometric view of a single mesh heating element made from ribbon formed with an integrated primary conductor and having a DER of less than 2.

FIG. 1c is an isometric view of a flat mesh heating element made from a single flat sheet incorporating primary conductor bars and having a DER of less than 2.

FIG. 2 is a cross sectional view of FIG. 1c illustrating the transition zone from the primary to the heating element.

FIG. 3 is an isometric view of a segmented mesh formed from the mesh in FIG. 1c.

FIG. 4 is an isometric view of a tensioning system used to hold the mesh of FIG. 3.

FIG. 5 is an isometric view of a roll of sequentially formed elements such as that in FIG. 1c so as to create a continuous string of elements.

FIG. 6 is an isometric view of the manufacturing process used to make the element of FIG. 1c further including a coating process.

FIG. 7 is a table describing various thickness of mesh and their appropriate mesh size to maintain a DER less than 2 and operate at various sizes.

FIG. 8 is an isometric and schematic drawing illustrating how the DER value is calculated.

FIG. 9 is an isometric view of the element of FIG. 3 with a modified union end to allow for an equal resistive value.

FIG. 10 is an isometric view of the element of FIG. 3 and similar to that in FIG. 9.

FIG. 11 is a table showing the equal resistance of the path lengths across the width of the element in FIG. 10.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DESCRIPTION

The present teachings disclose a novel heating element with a DER of less than 2 incorporating a primary element that does not require the need to weld or otherwise join the primary to the mesh.

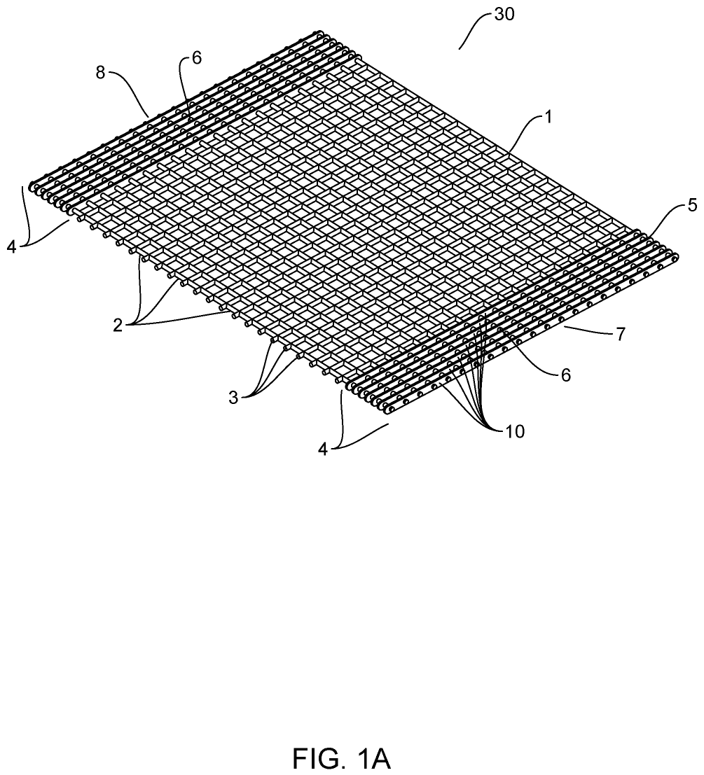

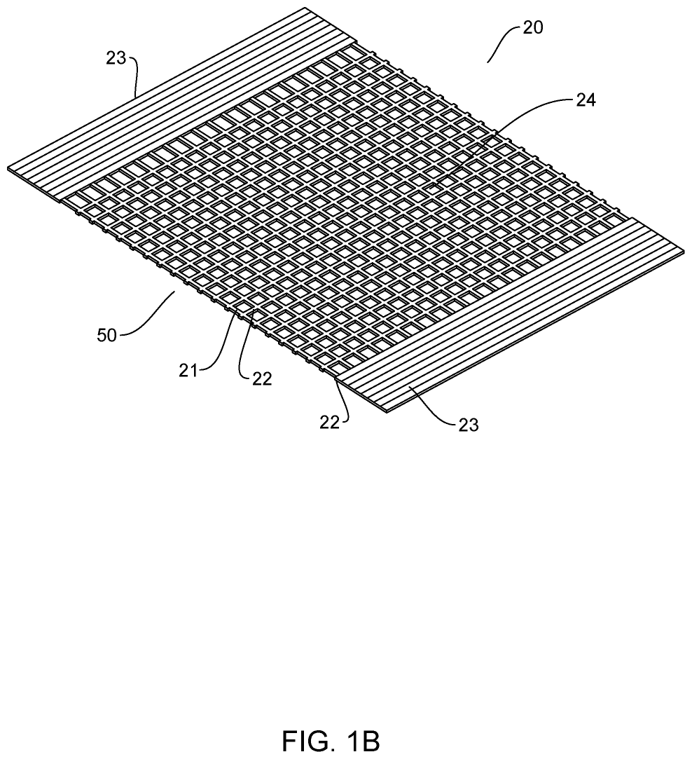

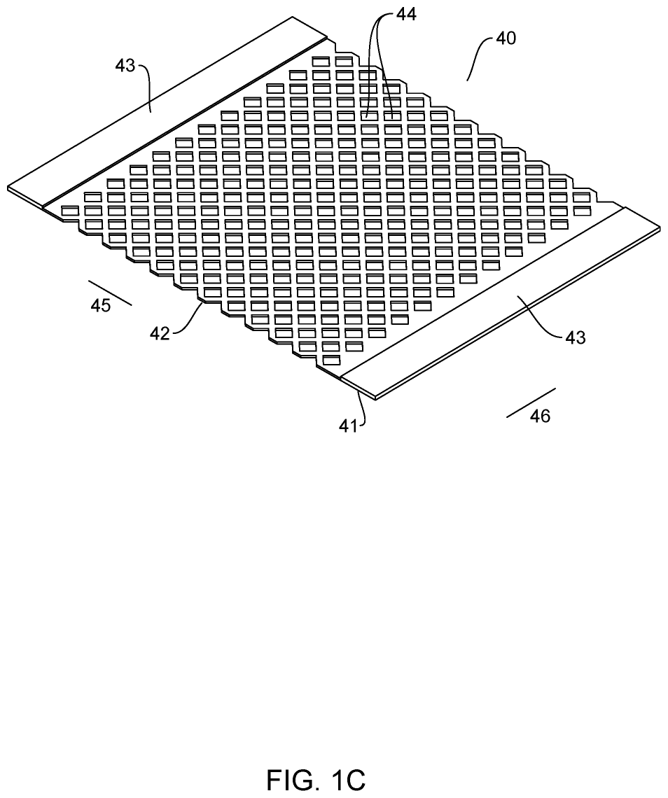

FIG. 1a is an isometric view of a single wire mesh heating element 30 formed with an integrated primary conductor and having a DER of less than 2. The wire mesh 1 is formed with cross elements 2 across which a voltage is applied from one side of the oven to the other and wire elements 3 are normally woven orthogonally to 2. A typical wire mesh used in the application might have a wire diameter of 0.012″ and be spaced 0.055″ from each other so as to form a mesh with 18 strands crossed. In accordance with the present invention, wire elements 3 may be pressed closer together at space 4 or wire that is larger in diameter such as strand 5 may be woven into the mesh to create a primary conductor section 6 of the element that is integrated into the heating element. Such a primary conductor, having a significantly lower electrical resistance than the mesh heater section should help to lower the temperature of the mesh at the ends 7 and 8. As an example, by decreasing the spacing 4 between strands at the end by half (from 0.055″ to 0.0275″) and increasing the diameter of wires 10 by two fold (to 0.024″ and thus increasing the cross sectional area of the cross wire 3 by 4 times and together with wire 2, the overall cross sectional area is increased by 2.5 times), and the resistance is thus decreased by 40% in the end primary conductor bar section.

Similarly to element 30 in FIG. 1a, FIG. 1b is an isometric view of element 20 having flattened wire or ribbon 21 and 22 cross woven together to form a mesh 50. Also like mesh 30, the cross flat ribbon 22 is moved closer together in the primary conductor area 23 and a ribbon with twice the thickness is used so as to create a primary conductor that like element 30 has 40% less of the electrical resistance of the mesh in region 24.

In a preferred embodiment, element 40 in FIG. 1c is formed from a solid sheet 41 that is chemically or electrically etched so as to create a heater mesh region 42 and a primary conductor section 43. As illustrated, the primary conductor region 43 having an electrical resistance of 75% less than mesh area 42 as the material is twice as thick and has no perforations 44. Unlike ribbon mesh 20 in FIG. 1b, both the length direction 45 and cross direction 46 can be increased in thickness. In addition, the ability to connect a secondary conductor to the primary in area 43 is much easier as the material is flat and stiff.

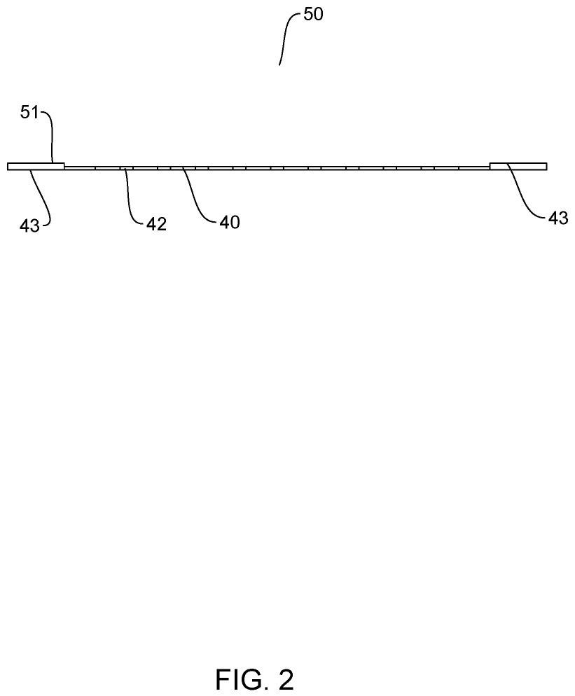

FIG. 2 illustrates a cross sectional view 50 of element 40. At the interface step 51 between the mesh region 42 and the conductor section 43, the current flowing from the secondary conductor bar enters the mesh. The use of a step that increases the material thickness above the interface 51 helps to insure that residual heat can be absorbed by the added metal in order to keep the zone cool. In addition, various gradations of thickness in the mesh region 42 can be created using an etching process that can help to increase the overall life of the mesh by reducing fatigue or temperature in the zone. As an example, initial current flow from the primary conductor 43 may create areas in the mesh 42 that are initially hotter compared to the rest of the mesh. Over thousands of cycles of heat up and cool down, these areas may become more prone to stress fracture. Thus, thickness may be adjusted accordingly and variably over the mesh to increase thickness and thus decrease resistance, further increasing life of the mesh.

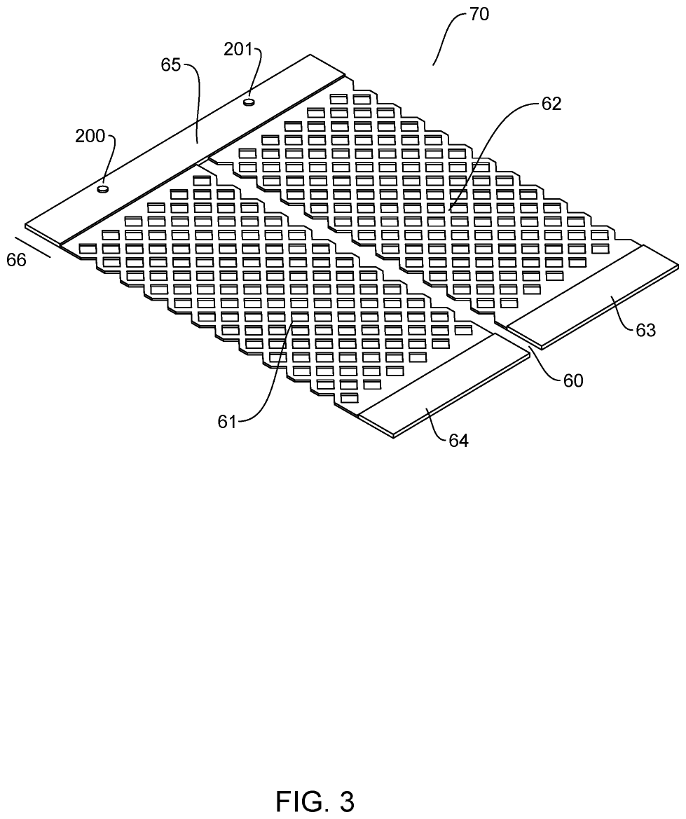

FIG. 3 is an isometric view of an element 40 such as that of FIG. 1c that has been segmented at line 60 into two equal zones 61 and 62 each with its own primary conductor 63 and 64 and an adjoining region 65 between the two to form element 70. Region 65 is designed to be used without a secondary conductor but further remain as cool as possible. By increasing the length of region 65 in direction 66, an additional reduction in the resistance is achieved. Region 66 may also be formed at a third thickness, different than the primary conductors at 63 and 64 and generally thicker. Holes 200 and 201 can be used for registration and location of the mesh within an oven.

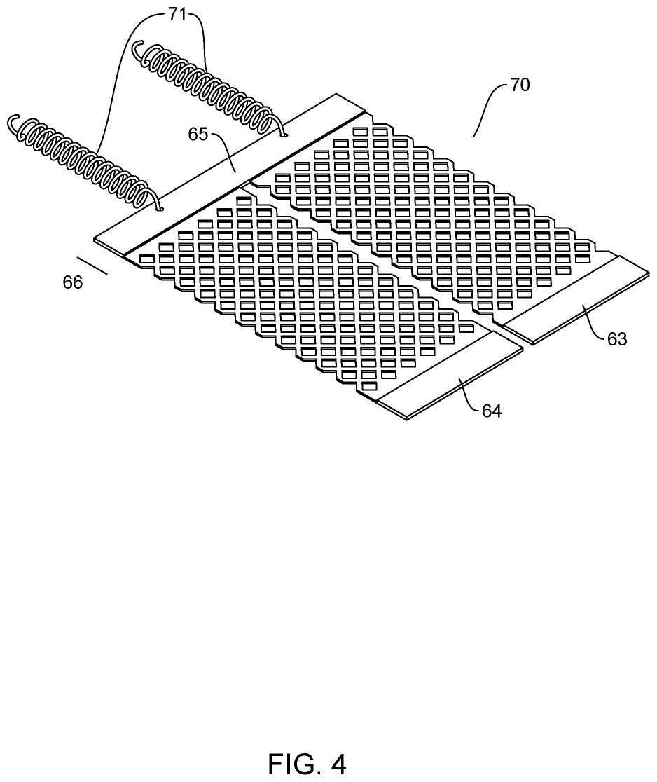

FIG. 4 is an illustration of element 70 that has been connected with a tensioning mechanism 71 at region 65 to create tension in direction 66 as the element is heated. The benefit of forming element 70 in this manner is that it helps to disassociate the current carrying ends 63 and 64 of element 70 from the tensioning mechanism 71 and thus simplifies the design mechanics of the secondary conductor bars.

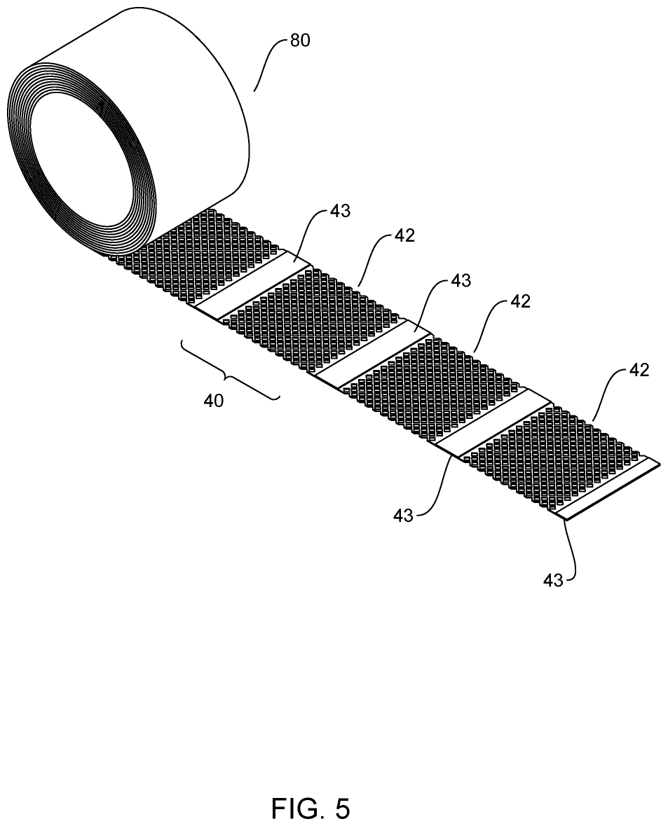

FIG. 5 illustrates a continuous roll 80 of the element 40 of FIG. 1c with mesh sections 42 following primary conductors 43 which may be reused as the roll is indexed. US patent application U.S. Ser. No. 15/183,967 describes a continuous mesh system yet does not use the primary conductors that greatly facilitate the current transfer to the mesh.

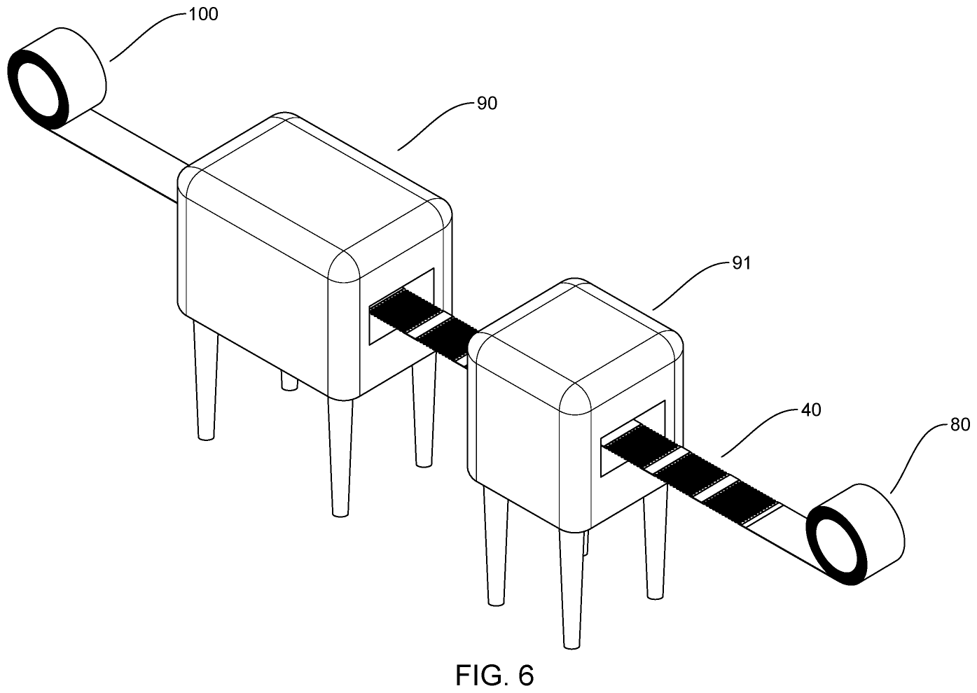

FIG. 6 illustrates a manufacturing process for etching and forming element 40 in the etcher 90 from blank roll stock 100 and further applying a coating 91. A continuous roll 80 may be produced by winding the finished product 40 into a roll 80 or by individually parting each element 40.

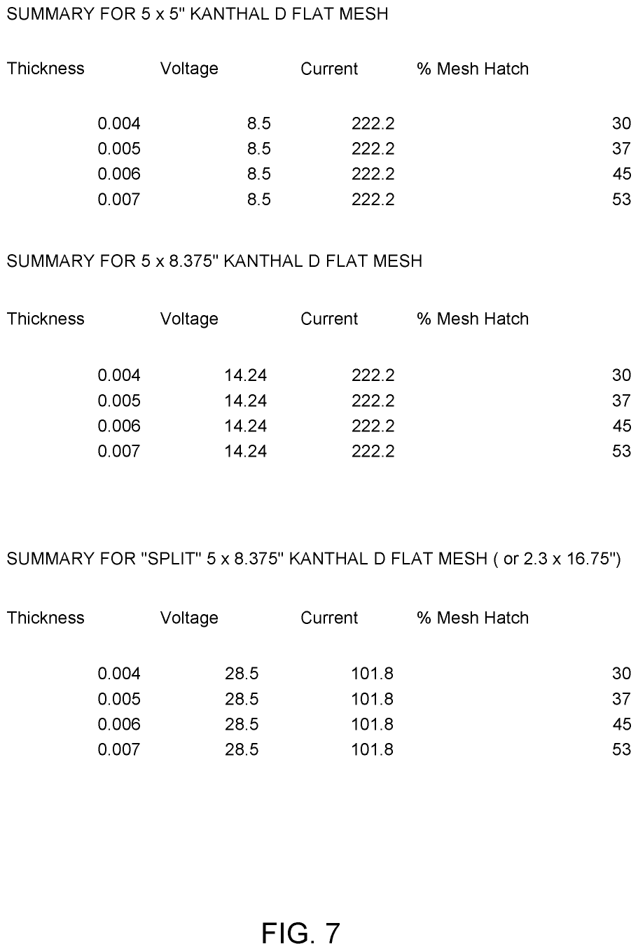

In the process of designing a flat film element 40 with perforations, the thickness is of crucial importance in the effective resistance. The thicker the material, the lower the resistance and therefore the more power will be required to make the element emit in the 0.5-3 micron range. The following table of FIG. 7 illustrates various mesh opening sizes for various elements of various thicknesses. Note that all these elements have a DER of less than 2.

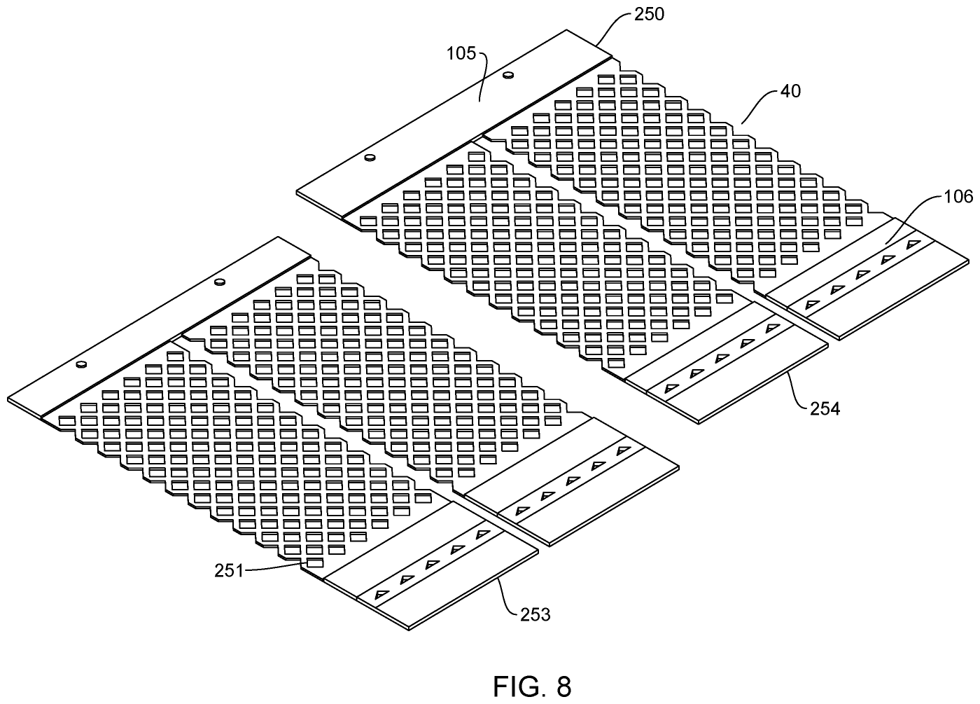

FIG. 8 Illustrates how to measure the DER as further described by De Luca in U.S. Pat. Nos. 8,498,526B2 and 9,500,374B2. In these calculations, the DER is calculated by considering a single mesh or element material covering an entire 0.25 m×0.25 m in an oven and further operating both elements simultaneously with energy applied in parallel to both a top and bottom element. By using this standardized approach to calculate the DER, the value will remain consistent and accurately reflect the properties of the material versus whether the material is made smaller or larger and whether it is used in various long or short configurations to obtain a different resistance.

Considering mesh 40 shown in FIG. 3, this mesh is 5″×8.375″ or 0.027 m2 on one side but with a 50% open area is 0.014 m2 of black body radiative area on one side or 0.027m2 per element. The single element 250 has a resistance of 0.14 ohms if measured end to end of the oven (across the 8″) or between edges 105 and 106. If 2 were placed in parallel with element 251 as shown in FIG. 8 to cover 0.25 m×0.25 m in the oven the resistance would drop to 0.07 ohms and the black body radiative area would increase to 0.055 m2. As explained in paragraph 25 of patent US20100166397 and beginning with line 43 of column 6 of U.S. Pat. No. 8,498,526B2 a typical oven with 0.25 m×0.25 m of area would have 4 surfaces or thus 2 more elements in parallel (253 and 254) powered through the same voltage source. Thus the resistance would again drop by 2 and the black body surface areas would increase by 2. So the total for a “standard” oven with this mesh would be 0.035 ohms and the black body radiative area would be 0.110 m2. Thus, the DER would equal 0.035/0.11=0.31

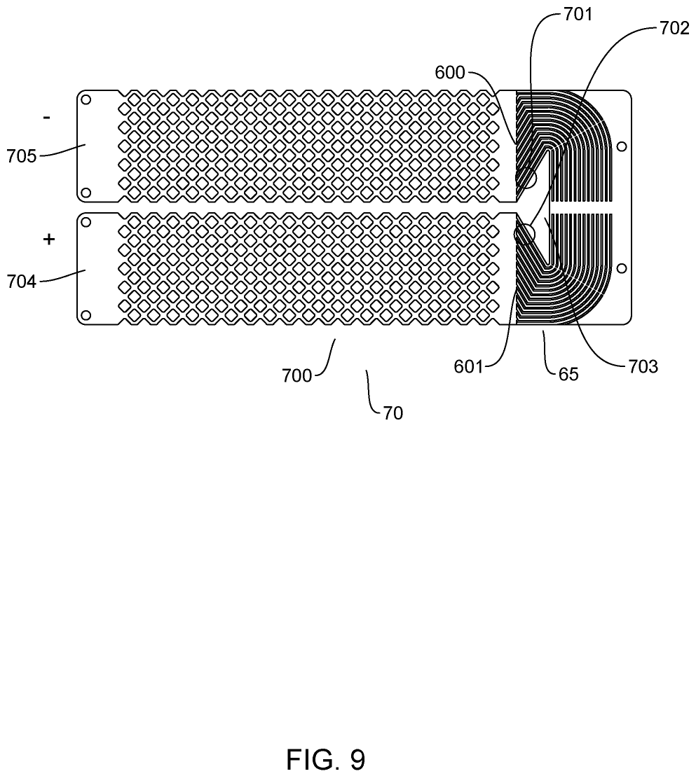

FIG. 9 illustrates the elements of FIGS. 3 and 4 where the element 70 made as element 700 has a modified region 65 of the element with a resistance that is equal across the intersection area 600 and 601 between the thinned section and the union and a hole 703. By creating a modified pathway 800 with equal resistance for the current to traverse between the positive end 704 and the negative end 705 through the union 65, the regions 701 and 702 remain cooler as the current passes more evenly throughout union 65.

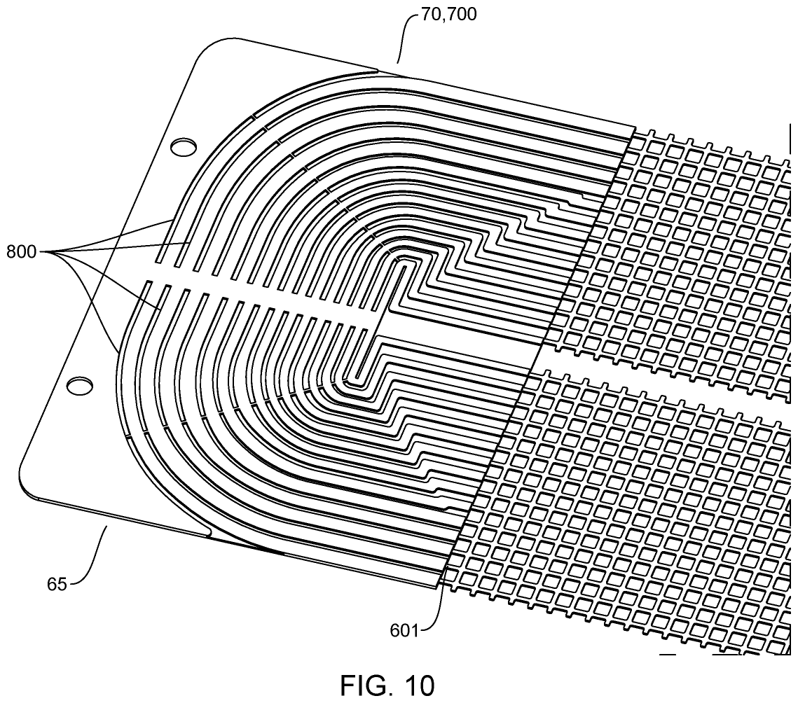

Similarly, to FIG. 9, FIG. 10 illustrates a flat element 70 and 700 with a modified union end 65 formed with pathways 800.

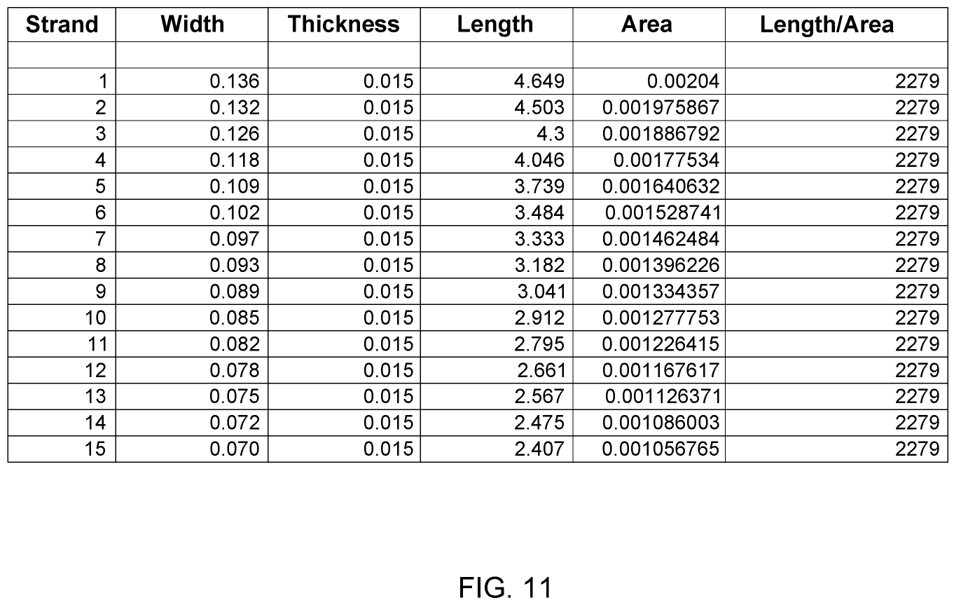

The table of FIG. 11 shows the equal resistance of each of the pathways 800 across the union end of the elements in FIG. 10.

The examples presented herein are intended to illustrate potential and specific implementations. It can be appreciated that the examples are intended primarily for purposes of illustration for those skilled in the art. The diagrams depicted herein are provided by way of example. There can be variations to these diagrams or the operations described herein without departing from the spirit of the invention. For instance, in certain cases, method steps or operations can be performed in differing order, or operations can be added, deleted or modified.

What is claimed is:

1. A heater element comprising:
a primary conductor formed from a single sheet of metal, wherein the primary conductor is capable of radiating heat within 5 seconds and has a DeLuca Element Ratio of less than 2 ohms/m²; and
primary conductor bars that are not welded to the primary conductor.

2. The heater element of claim 1 wherein the single sheet of metal comprises two or more thicknesses.

3. The heater element of claim 1, wherein the primary conductor is shaped into a U shape.

4. The heater element of claim 3 wherein the U-shape comprises ends and a curve, the ends of the U are connected to an electrical circuit, and the curve is tensioned with a tensioner.

5. The heater element of claim 3 wherein a portion of the curve comprises multiple pathways for a current to flow.

6. The heater element of claim 1 wherein the heater element is adapted to increase in temperature during operation at a rate of greater than 100 degrees C. per second.

7. The heater element of claim 1 wherein the single sheet of metal comprises a mesh or lattice structure.

8. The planar element per claim 1 wherein the single sheet of metal comprises planar sections having a thickness greater than 0.001 inches.

9. The heater element per claim 1 wherein the single sheet of metal comprises ends and a middle part to radiate disposed between the ends, and a thickness of each of the ends is greater than a thickness of the middle part.

10. The heater element per claim 1 wherein the single sheet of metal is a portion of a roll or continuous sheet.

11. A process for making a heating element from a single sheet of metal comprising providing a sheet having two or more thicknesses formed either singularly or sequentially.

12. The process per claim 11 further comprising installing said heater element within an oven cavity.

13. The process of claim 11 further comprising welding the two or more sheet parts.

14. The process of claim 11 further comprising supplying electrical power from a power supply to the multi-planar heating element.

15. The process of claim 14 wherein the power supply delivers AC or DC current to the multi-planar heating element.

16. The process of claim 14 further comprising storing electrical energy to operate the multi planar heating element.

17. The process of claim 14 wherein said power supply delivers power to said heater element through a switch.

18. The process of claim 14 further comprising cycling on and off the electrical energy supplied to the multi-planar element is turned.

19. The process of claim 14 further comprising controlling electrical energy supplied to the multi-planar heating element with a feedback loop comprising input from a sensor.

20. The process of claim 11 further comprising providing an oven cavity; and monitoring a temperature rise in the oven cavity when the multi-planar heating element is in use.

21. The process of claim 11 further comprising cycling the multi-planar heating element on and off.

22. The process of claim 11 further comprising cycling the multi-planar heating element in association with a pre-set program.

23. The process of claim 11 further comprising submerging the multi-planar heating element in a liquid.
